(19) United States
(12) Patent Application Publication
(10) Pub. No.: US 2011/0011690 A1
(43) Pub. Date: Jan. 20, 2011

(54) HYDRAULIC PRESSURE CONTROL APPARATUS FOR TORQUE CONVERTER

(75) Inventor: Osamu SAKAMOTO, Handa-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/836,240

(22) Filed: Jul. 14, 2010

(30) Foreign Application Priority Data
Jul. 16, 2009 (JP) 2009-167806

(51) Int. Cl. F16H 61/14

(52) U.S. Cl. 192/3.29

(57) ABSTRACT

A hydraulic pressure control apparatus for a torque converter, the torque converter including a pump impeller configured to rotate, a turbine runner configured to rotate in response to fluid transmitted from the pump impeller and a lock-up clutch adapted to directly connect the turbine runner to a power source, includes a control valve outputting a lock-up pressure for engaging the lock-up clutch by controlling a hydraulic pressure outputted by a hydraulic pressure source and a relay valve including a first switching portion for selectively allowing and interrupting a communication between the control valve and the lock-up clutch, wherein the relay valve interrupts the communication between the control valve and the lock-up clutch by means of the first switching portion when a value of the lock-up pressure outputted by the control valve is a predetermined value or more.

### CROSS REFERENCE TO RELATED APPLICATIONS

This application is based on and claims priority under 35 U.S.C. §119 to Japanese Patent Application 2009-167806, filed on Jul. 16, 2009, the entire content of which is incorporated herein by reference.

### TECHNICAL FIELD

This disclosure relates to a hydraulic pressure control apparatus for a torque converter, the hydraulic pressure control apparatus controlling hydraulic pressure applied to engaging elements of the torque converter having a lock-up clutch adapted to connect a turbine runner directly to a power source.

### BACKGROUND DISCUSSION

Generally, automatic transmissions include, on a power transmission path between a power source and a transmission, a hydraulic power transmission configured by a torque converter or a fluid coupling adapted to transmit a torque from a power source continuously from a stall state to a directly connected state of an output shaft of the power source and an input shaft of the transmission. Further, a known torque converter includes a lock-up clutch adapted to connect the pump impeller and the turbine runner in order eliminate a rotational speed difference between the power source and the turbine runner when the rotational speed difference between the pump impeller and the turbine runner is small, thereby eventually reducing the fuel consumption during a drive of a vehicle. The lock-up clutch is controlled to be engaged by a hydraulic pressure control of the hydraulic pressure control apparatus.

A hydraulic pressure control apparatus for a hydraulic power transmission having a lock-up clutch disclosed in JP2006-349007A includes a lock-up control valve and a lock-up relay valve. The lock-up control valve adjusts a level of a lock-up pressure used for engaging the lock-up clutch. The lock-up relay valve has a function for switching an inner pressure of the hydraulic power transmission (e.g., a hydraulic pressure in the hydraulic power transmission) to be low or high and a function for selectively allowing and interrupting a communication between the lock-up control valve and a lock-up piston.

According to the hydraulic pressure control apparatus disclosed in JP2006-349007A, due to a malfunction of the lock-up control valve or a malfunction of a regulator valve for generating an original pressure for the lock-up control valve, an excess hydraulic pressure may be applied to the lock-up clutch provided in the hydraulic power transmission, thereby damaging the hydraulic power transmission. In order to eliminate a possibility of such damage to the hydraulic power transmission, a state where a level of the lock-up pressure is excessively high may be detected, and the lock-up relay valve may interrupt a flow of the lock-up pressure to the lock-up clutch by means of the lock-up relay valve when the level of the lock-up pressure is excessively high. However, in this configuration, because an additional sensor and software for controlling the lock-up relay valve so as to interrupt the flow of the lock-up pressure need to be provided to detect the state where the level of the lock-up pressure is excessively high, costs of the hydraulic pressure control apparatus may be increased.

A need thus exists for a hydraulic pressure control apparatus for a hydraulic power transmission such as a torque converter, which is not susceptible to the drawback mentioned above.

### SUMMARY

According to an aspect of this disclosure, a hydraulic pressure control apparatus for a torque converter, the torque converter including a pump impeller configured to rotate, a turbine runner configured to rotate in response to fluid transmitted from the pump impeller and a lock-up clutch adapted to directly connect the turbine runner to a power source, includes a control valve outputting a lock-up pressure for engaging the lock-up clutch by controlling a hydraulic pressure outputted by a hydraulic pressure source and a relay valve including a first switching portion for selectively allowing and interrupting a communication between the control valve and the lock-up clutch, wherein the relay valve interrupts the communication between the control valve and the lock-up clutch by means of the first switching portion when a value of the lock-up pressure outputted by the control valve is a predetermined value or more.

According to another aspect of this disclosure, a hydraulic pressure control apparatus for a torque converter, the torque converter including a pump impeller configured to rotate, a turbine runner configured to rotate in response to fluid transmitted from the pump impeller and a lock-up clutch adapted to directly connect the turbine runner to a power source, includes a control valve outputting a lock-up pressure adapted to engage the lock-up clutch by controlling a hydraulic pressure outputted by a hydraulic pressure source in accordance with a hydraulic pressure based on a signal of a second solenoid valve, a relay valve including a first switching portion for switching a communication state of the lock-up pressure outputted by the control valve relative to the lock-up clutch and an electronic control unit for controlling an application of an electric current to the second solenoid valve, wherein the electronic control unit switches the relay valve so as to limit the lock-up pressure, introduced to the lockup clutch from the control valve, by means of the first switching portion, when a value of the lock-up pressure outputted by the control valve is a predetermined value or more.

### BRIEF DESCRIPTION OF THE DRAWINGS

The foregoing and additional features and characteristics of this disclosure will become more apparent from the following detailed description considered with the reference to the accompanying drawings, wherein:

FIG. 1 illustrates a configuration diagram schematically indicating a hydraulic pressure control apparatus for a hydraulic power transmission such as a torque converter in a first embodiment; and

FIG. 2 illustrates a configuration diagram schematically indicating a hydraulic pressure control apparatus for a hydraulic power transmission such as a torque converter in a second embodiment.

### DETAILED DESCRIPTION

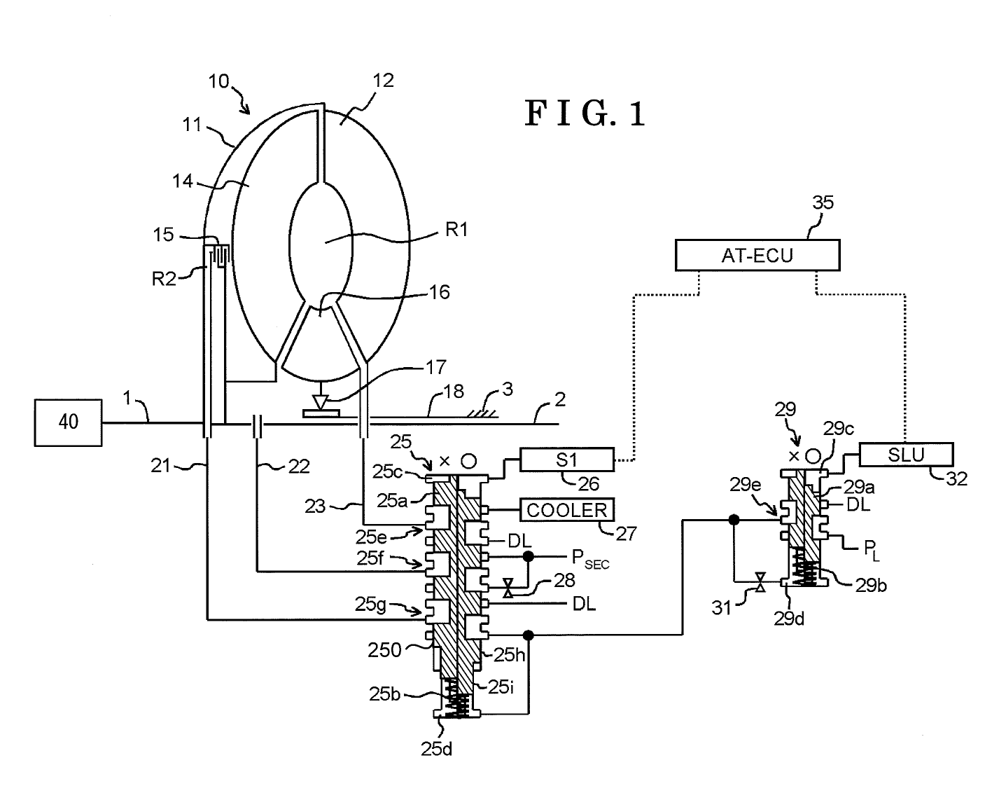

A hydraulic pressure control apparatus for a hydraulic power transmission of embodiments related to this disclosure will be described. The hydraulic pressure control apparatus controls the hydraulic power transmission that is configured by a pump impeller (12 in FIG. 1), a turbine runner (14 in FIG. 1), a lock-up clutch (15 in FIG. 1) and the like. The turbine runner 14 is rotated in response to an oil flow caused by rotations of the pump impeller 12, and the lock-up clutch 15 is operated so as to directly connect the turbine runner 14 to a power source 40 (e.g., an output shaft 1 in FIG. 1). The hydraulic pressure control apparatus includes a mechanism having a control valve (29 in FIG. 1) and a relay valve (25 in FIG. 1). The control valve 29 outputs a lock-up pressure, by which the lock-up clutch 15 is engaged, by adjusting the hydraulic pressure from a hydraulic pressure source (e.g., a secondary pressure), and the relay valve 25 includes a first switching portion (25g in FIG. 1) selectively allowing and interrupting a communication between the control valve 29 and the lock-up clutch 15. The relay valve 25 interrupts the communication between the lock-up clutch 15 and the control valve 29 by the first switching portion 25g when the lock-up pressure outputted by the control valve 29 is equal to or more than the a predetermined pressure value. More specifically, the relay valve 25 interrupts the communication between the control valve 29 and the lock-up clutch 15 when a hydraulic pressure within a spring chamber 25d in FIG. 1 reaches a predetermined value or more.

### FIRST EMBODIMENT

The hydraulic pressure control apparatus for the hydraulic power transmission of a first embodiment related to this disclosure will be described in accordance with the attached drawings. FIG. 1 illustrates a configuration diagram schematically indicating the hydraulic pressure control apparatus for the hydraulic power transmission in the first embodiment.

The hydraulic pressure control apparatus for the hydraulic power transmission of the first embodiment shown in FIG. 1 corresponds to a hydraulic pressure control apparatus for a torque converter 10 which includes the lock-up clutch 15 by which a communication between the pump impeller 12 and the turbine runner 14 is allowed when a rotational speed difference between the pump impeller 12 and the turbine runner 14 is relatively small in order to eliminate a rotational speed difference between a power source 40 (e.g., an engine) and the turbine runner 14. The hydraulic pressure control apparatus controls a hydraulic pressure to be applied to the lock-up clutch 15 to establish an engaging state of the lock-up clutch 15 and so as not to applied to the lock-up clutch 15 to establish a disengaging state of the lock-up clutch 15. The hydraulic pressure control apparatus includes a lock-up clutch passage 21, an inlet side fluid passage 22 of the torque converter, an outlet side fluid passage 23 of the torque converter, the lock-up relay valve 25 (e.g., a relay valve), a first solenoid valve 26 (S1), a cooler 27, an orifice 28, the lock-up clutch control valve 29 (e.g., a control valve), an orifice 31, a second solenoid valve 32 (SLU) and an electronic control unit 35.

The torque converter 10 is a hydraulic power transmission which generates torque multiplication by use of a rotational speed difference between the pump impeller 12 provided at an input side and the turbine runner 14 provided at an output side by applying hydrodynamic action. The torque converter 10 is disposed on a power transmission path between the output shaft 1 of the power source 40 and an input shaft 2 of a transmission. The torque converter 10 includes a converter shell 11, the pump impeller 12, the turbine runner 14, the lock-up clutch 15, a stator 16, a one-way clutch 17, a stator shaft 18, a hydraulic power transmitting chamber R1 and a lock-up clutch hydraulic pressure chamber R2.

The converter shell 11 serves as a casing for the torque converter 10. The converter shell 11 normally rotates integrally with the output shaft 1 of the power source 40 and the pump impeller 12. Components of the torque converter 10 and an operational fluid (e.g., oil) are provided within the converter shell 11. The converter shell 11 is configured to relatively rotate with the turbine runner 14 and to rotate integrally with the turbine runner 14 when the lock-up clutch 15 is engaged (e.g., the engaging state).

The pump impeller 12 is an impeller which rotates to send the operational fluid to the turbine runner 14. The pump impeller 12 is configured to integrally rotate with the converter shell 11.

The turbine runner 14 is an impeller which rotates when receiving the operational fluid sent by the pump impeller 12. The turbine runner 14 normally rotates integrally with the input shaft 2 of the transmission. The turbine runner 14 is configured to relatively rotate with the converter shell 11 and to integrally rotate with the converter shell 11 when the lock-up clutch 15 is engaged (e.g., the engaging state).

The lock-up clutch 15 is a multi-plate clutch mechanism which eliminates the rotational speed difference between the power source 40 (e.g., the engine) and the turbine runner 14 by directly connecting the pump impeller 12 to the turbine runner 14 when the rotational speed difference between the pump impeller 12 and the turbine runner 14 is small. When the lock-up clutch 15 is engaged, torque of the converter shell 11 is transmitted to the turbine runner 14. The lock-up clutch 15 includes an input side clutch plate which is connected to the converter shell 11 not to be relatively rotatable but to be movable in an axial direction, an output side clutch plate connected to the turbine runner 14 not to be relatively rotatable but to be movable in an axial direction, and a piston which is pushed out by applying the hydraulic pressure in the lock-up clutch hydraulic pressure chamber R2. The input side clutch plates and the output side clutch plates are arranged alternately to each other in the lock-up clutch 15, and the piston pushes the input side clutch plate to the output side clutch plate to frictionally engage the input side clutch plate and the output side clutch plate.

The stator 16 is disposed between the turbine runner 14 and the pump impeller 12 closer to a radially inner portion of the torque converter 10 and corresponds to an impeller which generates torque multiplication by adjusting and returning the operational fluid discharged from the turbine runner 14 to the pump impeller 12. The stator 16 is fixed to a transmission case 3 via the one-way clutch 17 and the stator shaft 18 and is configured to rotate only in one direction.

The one-way clutch 17 allows the stator 16 to rotate only in one direction. The stator 16 is fixed to a rotational end of the one-way clutch 17. A fixed end of the one-way clutch 17 is fixed to the transmission case 3 via the stator shaft 18.

The stator shaft 18 is a shaft-shaped member for fixing the fixed end of the one-way clutch 17 to the transmission case 3.

The hydraulic power transmission chamber R1 accommodates the pump impeller 12, the turbine runner 14, and the stator 16, and is filled with the operational fluid. The hydraulic pressure is applied to the hydraulic power transmission chamber R1 via the inlet side fluid passage 22, and the hydraulic pressure is discharged from the hydraulic power transmission chamber R1 via the outlet side fluid passage 23.

The lock-up clutch hydraulic pressure chamber R2 is arranged for operating the lock-up clutch 15. The lock-up clutch hydraulic pressure chamber R2 is connected to the lock-up clutch passage 21. In a case where a hydraulic pressure higher than a hydraulic pressure in the hydraulic power transmission chamber R1 is applied to the lock-up clutch hydraulic pressure chamber R2, the lock-up clutch 15 is engaged, and the lock-up clutch 15 is released in a case where a hydraulic pressure in the lock-up clutch hydraulic pressure chamber R2 is lower than a hydraulic pressure in the hydraulic power transmission chamber R1.

The lock-up clutch passage 21 is a fluid passage by which the lock-up clutch hydraulic pressure chamber R2 is connected to the switching portion 25g (e.g., a first switching portion) of the lock-up relay valve 25. The inlet side fluid passage 22 is a fluid passage by which a hydraulic pressure from a switching portion 25f (e.g., a second switching portion) of the lock-up relay valve 25 is applied to the hydraulic power transmitting chamber R1 of the torque converter 10. The outlet side fluid passage 23 is a fluid passage by which a hydraulic pressure from the hydraulic power transmitting chamber R1 of the torque converter 10 is applied to a switching portion 25e (e.g., the second switching portion) of the lock-up relay valve 25.

The lock-up relay valve 25 is a switching valve for switching (e.g., selecting) a fluid passage to be used. The lock-up relay valve 25 is formed with a valve body 250 within which a spool 25a, a spring 25b, a hydraulic pressure chamber 25c (e.g., a first hydraulic pressure chamber), the spring chamber 25d and the switching portions 25e, 25f and 25g are housed. The spool 25a is arranged so as to be slidable within the valve body 250. The spool 25a is formed so as to have a large diameter portion 25h and a small diameter portion 25i whose diameter is smaller than that of the large diameter portion 25h. The large diameter portion 25h is located so as to be slidable at the switching portions 25e, 25f and 25g, and the small diameter portion 25i located so as to be slidable within the spring chamber 25d. The spring 25b is arranged within the spring chamber 25d so as to bias the spool 25a toward the hydraulic pressure chamber 25c. The hydraulic pressure chamber 25c actuates so as to press the spool 25a toward the spring chamber 25d when a hydraulic pressure based on an ON/OFF signal of the first solenoid valve 26 is applied thereto. The spring chamber 25d houses the spring 25b, and a diameter of the spring chamber 25d is set so as to be smaller than a diameter of each of the switching portions 25e, 25f and 25g. The spool 25a slides toward the spring chamber 25d (in a state indicated by “o” in FIG. 1) when the pressing force generated within the hydraulic pressure chamber 25c (the hydraulic pressure based on an ON/OFF signal of the first solenoid valve 26) is greater than a total force of the biasing force of the spring 25b and a pressing force caused by the hydraulic pressure within the spring chamber 25d (e.g., an output pressure from the lock-up clutch control valve 29), and the spool 25a slides toward the hydraulic pressure chamber 25c (in a state indicated by “x” in FIG. 1) when the pressing force generated within the hydraulic pressure chamber 25c is lower than the total force of the biasing force of the spring 25b and the pressing force caused by the hydraulic pressure within the spring chamber 25d (e.g., the output pressure from the lock-up clutch control valve 29). The lock-up relay valve 25 includes the switching portion 25e by which the outlet side fluid passage 23 selectively communicates with either one of the cooler 27 and a drain port (DL). Specifically, the switching portion 25e establishes a communication between the outlet side fluid passage 23 and the cooler 27 when the lock-up relay valve 25 is in the state indicated by “x” in FIG. 1 and establishes a communication between the outlet side fluid passage 23 and the drain port (DL) when the lock-up relay valve 25 is in the state indicated by “o” in FIG. 1. The lock-up relay valve 25 further includes the switching portion 25f by which the inlet side fluid passage 22 communicates with an input port of a secondary pressure (PSEC). Specifically, the switching portion 25f establishes a communication between the inlet side fluid passage 22 and the input port of the secondary pressure (PSEC) when the lock-up relay valve 25 is in the state indicated by “x” in FIG. 1 and establishes a communication between the inlet side fluid passage 22 and the input port of the secondary pressure (PSEC) via the orifice 28 when the lock-up relay valve 25 is in the state indicated by “o” in FIG. 1.

Thus, the switching portions 25e and 25f are operated so as to be in the state indicated by “x” in FIG. 1, where the secondary pressure (PSEC) flows to the hydraulic power transmitting chamber R1 and then flows to the cooler 27, thereby the inner pressure of the torque converter 10 (e.g., a level of a hydraulic pressure in the torque converter 10) is switched to be a higher pressure, and the switching portions 25e and 25f are operated so as to be in the state indicated by “o” in FIG. 1, where the secondary pressure (PSEC) flows via the orifice 28, at which the amount of the operational fluid is controlled, to the hydraulic power transmitting chamber R1 and then is discharged through the drain port (DL), thereby the inner pressure of the torque converter 10 (e.g., the level of the hydraulic pressure in the torque converter 10) is switched to be a lower pressure. The lock-up relay valve 25 includes the switching portion 25g by which the lock-up clutch passage 21 selectively communicates with either one of the drain port (DL) and the lock-up clutch controlling valve 29. Specifically, the switching portion 25g establishes a communication between the lock-up clutch passage 21 and the drain port (DL) when the lock-up relay valve 25 is in the state indicated by “x” in FIG. 1 and establishes a communication between the lock-up clutch passage 21 and the lock-up clutch controlling valve 29 when the lock-up relay valve 25 is in the state indicated by “o” in FIG. 1. When the communication between the lock-up clutch passage 21 and the lock-up clutch control valve 29 is established by means of the switching portion 25g (the lock-up relay valve 25 is in the state indicated by “o” in FIG. 1), the inner pressure of the torque converter 10 (e.g., the level of the hydraulic pressure in the torque converter 10) is controlled so as to be the lower pressure by means of the switching portions 25e and 25f, and when the communication between the lock-up clutch passage 21 and the lock-up clutch control valve 29 is interrupted by means of the switching portion 25g (the lock-up relay valve 25 is in the state indicated by “x” in FIG. 1), the inner pressure of the torque converter 10 (e.g., the level of the hydraulic pressure in the torque converter 10) is controlled so as to be the higher pressure by means of the switching portions 25e and 25f. Here, the secondary pressure (PSEC) corresponds to a hydraulic pressure that is adjusted by reducing the hydraulic pressure outputted from an oil pump (i.e., line pressure).

The first solenoid valve 26 is an on/off type solenoid valve for controlling an application of a hydraulic pressure to the hydraulic pressure chamber 25c of the look-up relay valve 25 in response to a state of the first solenoid valve 26 (an energized or non-energized state). Specifically, the first solenoid valve 26 has a normally low (NL) characteristic where a hydraulic pressure is outputted when the first solenoid valve 26 is in the energized state and the hydraulic pressure is not outputted when the first solenoid valve 26 is in the non-energized state. The first solenoid valve 26 is controlled by the electronic control unit 35. A linear type solenoid valve, by which a level of a hydraulic pressure may be adjusted in accordance with an electrical current amount, may be used instead of the on/off type solenoid valve 26.

The cooler 27 is an instrument by which a temperature of the operational fluid within the hydraulic pressure circuit is reduced. The operational fluid is cooled by the cooler 27 as follows. The operational fluid discharged from the switching portion 25e of the lock-up relay valve 25 flows in the cooler 27 via the fluid passage, and the operational fluid emits its heat at the cooler 27, and the operational fluid whose temperature is reduced is discharged to an oil pan.

The orifice 28 is used to regulate (control) an amount of the secondary pressure (PSEC). The operational fluid passing through the orifice 28 (regulated at the orifice 28) flows toward the switching portion 25f of the lock-up relay valve 25.

The lock-up clutch control valve 29 is a control valve for adjusting a hydraulic pressure (e.g., a line pressure PL) of the hydraulic pressure source in accordance with a hydraulic pressure based on an ON/OFF signal of the second solenoid valve 32 and outputting the adjusted hydraulic pressure. The lock-up clutch control valve 29 is formed with a valve body 250 within which a spool 29a, a spring 29b, a hydraulic pressure chamber 29c, a spring chamber 29d and switching portions 29e are provided.

The spool 29a is arranged so as to be slidable within the valve body 250, and the spring 29b is arranged within the spring chamber 29d so as to bias the spool 29a toward the hydraulic pressure chamber 29c. The hydraulic pressure chamber 29c is configured to normally act, by receiving the hydraulic pressure based on an ON/OFF signal of the second solenoid valve 32 that is normally introduced thereto, so as to press the spool 29a toward the spring chamber 29d. The spring chamber 29d houses the spring 29b, and a lock-up pressure outputted by the switching portion 29e is introduced (feedback) via the orifice 31. The spool 29a slides toward the spring chamber 29d (in a state indicated by “o” in FIG. 1) when the pressure force of the hydraulic pressure within the hydraulic pressure chamber 29c is greater than a total of the biasing force of the spring 29b and a pressing force on the basis of the hydraulic pressure generated within the spring chamber 29d (an output pressure from the switching portion 29e of the lock-up clutch control valve 29), and the spool 29a slides toward the hydraulic pressure chamber 29c (in a state indicated by “x” in FIG. 1) when the pressure force of the hydraulic pressure within the hydraulic pressure chamber 29c is lower than the total of the biasing force of the spring 29b and the pressing force on the basis of the hydraulic pressure generated within the spring chamber 29d (the output pressure from the switching portion 29e of the lock-up clutch control valve 29). The lock-up clutch control valve 29 includes the switching portion 29e by which the lock-up clutch control valve 29 establishes a communication between the drain port DL and each of the switching portion 25g of the lock-up relay valve 25, the spring chamber 25d and the spring chamber 29d of the lock-up clutch control valve 29, when the lock-up clutch control valve 29 is in the state indicated by “x” in FIG. 1, and establishes a communication between the hydraulic pressure source (line pressure PL source) and each of the switching portion 25g of the lock-up relay valve 25, the spring chamber 25d and the spring chamber 29d of the lock-up clutch control valve 29, when the lock-up clutch control valve 29 is in the state indicated by “o” in FIG. 1.

The orifice 31 is used to regulate (control) an amount of the operational fluid from the switching portion 29e of the lock-up clutch control valve 29 to the spring chamber 29d.

The second solenoid valve 32 is a linear solenoid valve that is adapted to control a hydraulic pressure applied to hydraulic pressure chamber 29c of the lock-up clutch control valve 29 on the basis of the electric current supplied thereto. The second solenoid valve 32 is a normally low (NL) valve. Specifically, the second solenoid valve 32 is configured to output a hydraulic pressure or outputs a hydraulic pressure by reducing the modulator pressure (Pmod) when the electric current is supplied to the second solenoid valve 32 (e.g., an energized state). Further, the second solenoid valve 32 is configured not to output a hydraulic pressure corresponding to the modulator pressure (Pmod) when the electric current is not supplied to the second solenoid valve 32 (e.g., a non-energized state). The second solenoid valve 32 is controlled by the electronic control unit 35.

The electronic control unit 35 is a computer that controls an operation of the first and second solenoid valves 26 and 32. The electronic control unit 35 performs information processing by executing a predetermined program (i.e., including a data base, a map, or the like) on the basis of signals sent from various sensors of a vehicle. The electronic control unit 35 monitors rotational speeds of the engine and the input shaft of the transmission, and when a rotational speed difference therebetween becomes equal to or lower than a predetermined number, the electronic control unit 35 controls the lock-up clutch 15 to be engaged. Controlling operations of the electronic control unit 35 will be explained in more details hereinafter.

An actuation of the hydraulic pressure control apparatus of the torque converter of the first embodiment will be explained as follows.

### Actuation in Lock-up Off State

In a lock-up off state, the electronic control unit 35 controls the first solenoid valve 26 so as not to output a hydraulic pressure therefrom in order to move the lock-up relay valve 25 so as to be in the state indicated by “x” in FIG. 1 where the spring 25b is extended. In the state indicated by “x” in FIG. 1, a flow of a lock-up pressure outputted by the lock-up clutch control valve 29 through the switching portion 29e is interrupted by the lock-up relay valve 25, and the lock-up clutch 15 is communicated with the drain port (DL) via the switching portion 25g of the lock-up relay valve 25, consequently the torque converter turns in the lock-up off state (a state where the lock-up clutch 15 is disengaging).

### Actuation in Lock-up On State

In a lock-up on state, the electronic control unit 35 controls the first solenoid valve 26 so as to output a hydraulic pressure therefrom in order to move the lock-up relay valve 25 so as to be in the state indicated by “o” in FIG. 1 where the spring 25b is compressed. In the state indicated by “o” in FIG. 1, a lock-up pressure output port of the lock-up clutch control valve 29 is communicated with the switching portion 25g of the lock-up relay valve 25 so that the hydraulic pressure flows from the lock-up clutch control valve 29 to the lock-up clutch 15, consequently the torque converter turns in the lock-up on state (a state where the lock-up clutch 15 is engaging).

The lock-up relay valve 25 is designed in such a way that, when the lock-up pressure is introduced to the spring chamber 25d of the lock-up relay valve 25 from the lock-up clutch control valve 29 being normally operated, the pressing force of the hydraulic pressure generated within the hydraulic pressure chamber 25c (e.g., the hydraulic pressure based on an ON/OFF signal of the first solenoid valve 26) is greater than the total force of the biasing force of the spring 25b and a pressing force caused by the hydraulic pressure within the spring chamber 25d (e.g., an output pressure from the lock-up clutch control valve 29).

### Actuation When Excess Lock-up Pressure is Applied

In the lock-up on state, when the lock-up pressure is excessively generated due to a malfunction of the lock-up clutch control valve 29 and such excess lock-up pressure is introduced to the spring chamber 25d of the lock-up relay valve 25, the total force of the biasing force of the spring 25b and the pressing force caused by the hydraulic pressure within the spring chamber 25d (e.g., the output pressure from the lock-up clutch control valve 29) is greater than the pressing force of the hydraulic pressure generated within the hydraulic pressure chamber 25c (e.g., the hydraulic pressure based on an ON/OFF signal of the first solenoid valve 26). In this state, the spool 25a of the lock-up relay valve 25 is moved so as to be in the state indicated by “x” in FIG. 1, and the flow of the excess lock-up pressure outputted by the lock-up clutch control valve 29 through the switching portion 29e is interrupted by the lock-up relay valve 25, and the lock-up clutch 15 is communicated with the drain port (DL) through the switching portion 25g of the lock-up relay valve 25, consequently the torque converter turns in the lock-up off state (a state where the lock-up clutch 15 is disengaging).

According to the first embodiment, even when the lock-up pressure is excessively generated due to malfunctions of the lock-up clutch control valve 29 and the secondary regulator valve, the passage between the lock-up clutch control valve 29 and the lock-up clutch 15 is interrupted by the lock-up relay valve 25, and application of the excess hydraulic pressure to the lock-up clutch 15 is stopped in view of a hardware configuration. Thus, without providing a hydraulic pressure detecting sensor or an additional control program, the torque converter may be prevented from being damaged due to the excessive hydraulic pressure.

### SECOND EMBODIMENT

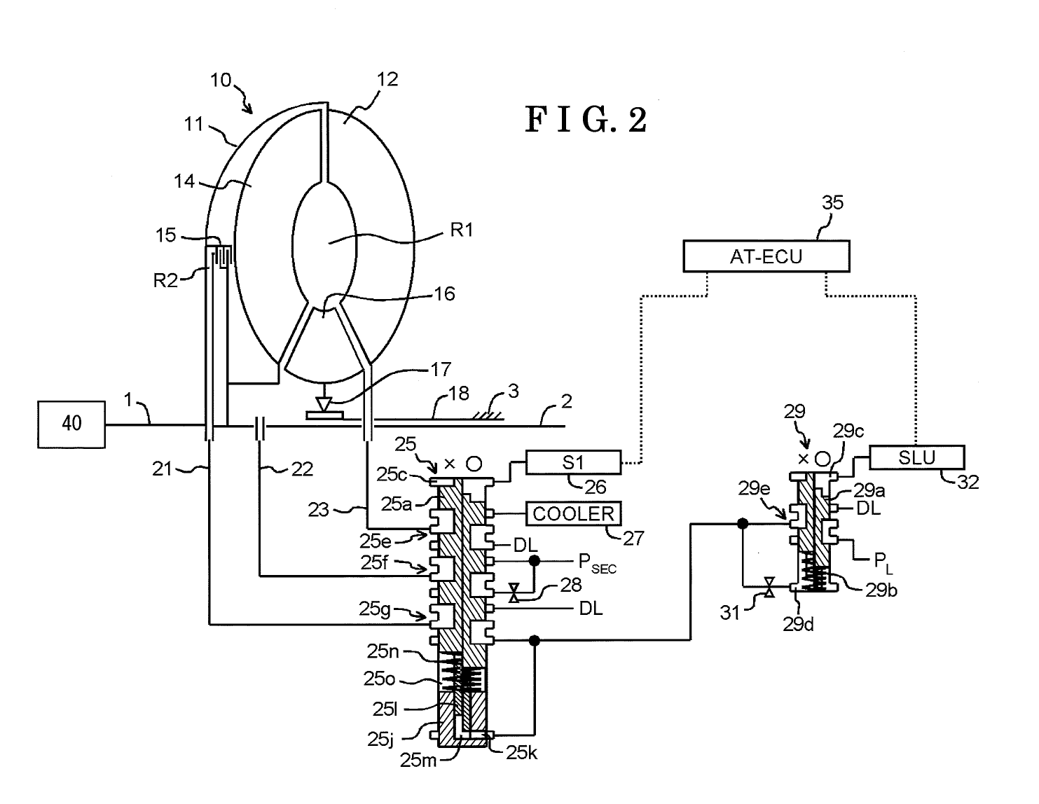

Actuation of the hydraulic pressure control apparatus of the hydraulic power transmission of a second embodiment will be explained as follows. FIG. 2 illustrates a configuration diagram schematically indicating a hydraulic pressure control apparatus for a hydraulic power transmission such as a torque converter in the second embodiment.

A lock-up relay valve 25 in FIG. 2 of the second embodiment is basically similar to the lock-up relay valve 25 in FIG. 1 of the first embodiment, except a configuration at a spring chamber of the lock-up relay valve 25 of the second embodiment being different from that of the first embodiment, and other configurations and actuations are similar to those of the first embodiment.

The lock-up relay valve 25 is formed with a valve body 250 within which a spool 25a, a spring 25n, a hydraulic pressure chamber 25c (a first hydraulic pressure chamber), a spring chamber 25o, a sleeve 25j and switching portions 25e, 25f and 25g are housed. The spool 25a is arranged so as to be slidable within the valve body 250. The spring 25n is arranged within the spring chamber 25o between the spool 25a and the sleeve 25j so as to bias the spool 25a toward the hydraulic pressure chamber 25c. The hydraulic pressure chamber 25c is operated so as to press the spool 25a toward the spring chamber 25o when a hydraulic pressure based on an ON/OFF signal of the first solenoid valve 26 is applied thereto. The spring chamber 25o is provided between the spool 25a and the sleeve 25j and houses the spring 25b. The sleeve 25j formed in a cylinder shape having a bottom at one end thereof is provided within the valve body 250, and the sleeve 25j is provided at one end portion of the valve body 250 (e.g., at the end portion where the hydraulic pressure chamber 25c is not provided), while the hydraulic pressure chamber 25c is provided at the other end portion of the valve body 250. The sleeve 25j is formed with a hydraulic pressure chamber 25m (e.g., a second hydraulic pressure chamber) formed at a radially inner portion of the sleeve 25j. The sleeve 25j includes a hole 25k through which a hydraulic pressure outputted by the lock-up clutch control valve 29 is introduced to the hydraulic pressure chamber 25m. A rod-shaped plunger 25l is inserted into the hydraulic pressure chamber 25m of the sleeve 25j so as to be slidable therewithin. The plunger 25l is arranged so as to be along an inner circumferential surface of the spring 25n, and when the hydraulic pressure from the lock-up clutch control valve 29 is introduced to the hydraulic pressure chamber 25m, the plunger 25l acts so as to press the spool 25 toward hydraulic pressure chamber 25c. The spool 25a slides toward the spring chamber 25o (in a state indicated by “o” in FIG. 2) when the pressing force generated within the hydraulic pressure chamber 25c (the hydraulic pressure based on an ON/OFF signal of the first solenoid valve 26) is greater than a total force of the biasing force of the spring 25n and a pressing force caused by the hydraulic pressure within the hydraulic pressure chamber 25m (e.g., an output pressure from the lock-up clutch control valve 29), and the spool 25a slides toward the hydraulic pressure chamber 25c (in a state indicated by “x” in FIG. 2) when the pressing force generated within the hydraulic pressure chamber 25c is lower than the total force of the biasing force of the spring 25n and the pressing force caused by the hydraulic pressure within the hydraulic pressure chamber 25m (e.g., the output pressure from the lock-up clutch control valve 29). The lock-up relay valve 25 includes the switching portion 25e by which the outlet side fluid passage 23 selectively communicates with either one of the cooler 27 and a drain port (DL). Specifically, the switching portion 25e establishes a communication between the outlet side fluid passage 23 and the cooler 27 when the lock-up relay valve 25 is in the state indicated by “x” in FIG. 2 and establishes a communication between the outlet side fluid passage 23 and the drain port (DL) when the lock-up relay valve 25 is in the state indicated by “o” in FIG. 2. The lock-up relay valve 25 further includes the switching portion 25f by which the inlet side fluid passage 22 communicates with an input port of a secondary pressure (PSEC). Specifically, the switching portion 25f establishes a communication between the inlet side fluid passage 22 and the input port of the secondary pressure (PSEC) when the lock-up relay valve 25 is in the state indicated by “x” in FIG. 2 and establishes a communication between the inlet side fluid passage 22 and the input port of the secondary pressure (PSEC) via the orifice 28 when the lock-up relay valve 25 is in the state indicated by “o” in FIG. 2. The lock-up relay valve 25 further includes the switching portion 25g by which the lock-up clutch passage 21 selectively communicates with either one of the drain port and the lock-up clutch control valve 29. Specifically, the switching portion 25g establishes a communication between the lock-up clutch passage 21 and the drain port (DL) when the lock-up relay valve 25 is in the state indicated by “x” in FIG. 2 and establishes a communication between the lock-up clutch passage 21 and the lock-up clutch control valve 29 when the lock-up relay valve 25 is in the state indicated by “o” in FIG. 2.

According to the second embodiment, in the same manner as the first embodiment, even when the lock-up pressure is excessively generated due to malfunctions of the lock-up clutch control valve 29 and the secondary regulator valve, the passage between the lock-up clutch control valve 29 and the lock-up clutch 15 is interrupted, and application of the excess hydraulic pressure to the lock-up clutch 15 is stopped in view of a hardware configuration. Consequently, without providing a hydraulic pressure detecting sensor or an additional control program, the torque converter may be prevented from being damaged due to the excessive hydraulic pressure.

According to this disclosure, when the lock-up pressure is excessively generated due to malfunctions of the control valve, the regulator valve of the hydraulic pressure source and the like, the communication between the lock-up clutch and the control valve is automatically interrupted by the relay valve. Thus, without providing a hydraulic pressure detecting sensor or an additional control program, which results in a cost increase, the torque converter may be prevented from being damaged due to the excessive hydraulic pressure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A hydraulic pressure control apparatus for a torque converter, the torque converter including a pump impeller configured to rotate, a turbine runner configured to rotate in response to fluid transmitted from the pump impeller and a lock-up clutch adapted to directly connect the turbine runner to a power source, wherein the hydraulic pressure control apparatus comprises:
a control valve outputting a lock-up pressure for engaging the lock-up clutch by controlling a hydraulic pressure outputted by a hydraulic pressure source; and
a relay valve including a first switching portion for selectively allowing and interrupting a communication between the control valve and the lock-up clutch,
wherein the relay valve interrupts the communication between the control valve and the lock-up clutch by means of the first switching portion when a value of the lock-up pressure outputted by the control valve is a predetermined value or more.

2. The hydraulic pressure control apparatus for the torque converter according to claim 1, wherein the relay valve includes a second switching portion by which a level of a hydraulic pressure in the torque converter is switched to be a higher pressure or a lower pressure, the level of the hydraulic pressure in the torque converter being switched to be the lower pressure by means of the second switching portion when the communication between the control valve and the lock-up clutch is allowed by means of the first switching portion, and the level of the hydraulic pressure in the torque converter being switched to be the higher pressure by means of the second switching portion when the communication between the control valve and the lock-up clutch is interrupted by means of the first switching portion.

3. The hydraulic pressure control apparatus for the torque converter according to claim 1, wherein the relay valve includes a spool being slidable within a valve body of the relay valve, a hydraulic pressure chamber provided at one end portion of the valve body in a sliding direction of the spool, a spring for biasing the spool toward the hydraulic pressure chamber and a spring chamber for accommodating the spring, and wherein a hydraulic pressure based on a signal of a first solenoid valve is introduced to the hydraulic pressure chamber, the lock-up pressure outputted by the control valve is introduced to the spring chamber, the spool slides toward the hydraulic pressure chamber when the lock-up pressure outputted by the control valve is equal to or more than a predetermined value and when a pressure force generated within the hydraulic pressure chamber is lower than the total force of the biasing force of the spring and the pressing force caused by the hydraulic pressure within the spring chamber, and the first switching portion interrupts the communication between the control valve and the lock-up clutch.

4. The hydraulic pressure control apparatus for the torque converter according to claim 3, wherein the spool is slidable within the valve body, and a portion of the spool being slidable within the spring chamber of the valve body is formed so as to have a diameter being smaller than that of the other portion of the spool being slidable within the valve body except the spring chamber.

5. The hydraulic pressure control apparatus for the torque converter according to claim 1, wherein the relay valve includes a spool being slidable within the valve body, a first hydraulic pressure chamber provided at one end portion of the valve body in a sliding direction of the spool, a sleeve provided at the other end portion of the valve body where the first hydraulic pressure chamber is not provided, a spring provided between the sleeve and the spool for biasing the spool toward the first hydraulic pressure chamber, a plunger adapted to slide on an inner circumferential surface of the sleeve and to press the spool toward the first hydraulic pressure chamber and a second hydraulic pressure chamber regulated by the sleeve and the plunger,
a hydraulic pressure based on a signal of the first solenoid valve is introduced to the first hydraulic pressure chamber,
the lock-up pressure outputted by the control valve is introduced to the second hydraulic pressure chamber, the spool slides toward the first hydraulic pressure chamber when the lock-up pressure outputted by the control valve is equal to or more than a predetermined value and when a pressure force generated within the first hydraulic pressure chamber is lower than the total force of the biasing force of the spring and the pressing force caused by the hydraulic pressure within the second hydraulic pressure chamber, and
the first switching portion interrupts the communication between the control valve and the lock-up clutch.

6. A hydraulic pressure control apparatus for a torque converter, the torque converter including a pump impeller configured to rotate, a turbine runner configured to rotate in response to fluid transmitted from the pump impeller and a lock-up clutch adapted to directly connect the turbine runner to a power source, wherein the hydraulic pressure control apparatus comprises:
a control valve outputting a lock-up pressure adapted to engage the lock-up clutch by controlling a hydraulic pressure outputted by a hydraulic pressure source in accordance with a hydraulic pressure based on a signal of a second solenoid valve;
a relay valve including a first switching portion for switching a communication state of the lock-up pressure outputted by the control valve relative to the lock-up clutch; and
an electronic control unit for controlling an application of an electric current to the second solenoid valve,
wherein the electronic control unit switches the relay valve so as to limit the lock-up pressure, introduced to the lockup clutch from the control valve, by means of the first switching portion, when a value of the lock-up pressure outputted by the control valve is a predetermined value or more.
